(19) United States
(12) Patent Application Publication
(10) Pub. No.: US 2025/0264413 A1
(43) Pub. Date: Aug. 21, 2025

(54) MgAlxGeyO3:zPr3+ PHOSPHORS AS TRACERS IN OIL RECOVERY APPLICATIONS

(71) Applicant: KING FAHD UNIVERSITY OF PETROLEUM AND MINERALS, Dhahran (SA)

(72) Inventors: Syed Niaz Ali SHAH, Dhahran (SA); Yafei CHEN, Dhahran (SA)

(73) Assignee: KING FAHD UNIVERSITY OF PETROLEUM AND MINERALS, Dhahran (SA)

(21) Appl. No.: 18/442,646

(22) Filed: Feb. 15, 2024

(51) Int. Cl. C09K 8/58; C01G 17/00; C09K 11/77; E21B 47/11

(52) U.S. Cl. CPC G01N 21/85

(57) ABSTRACT

A method including exciting a nanophosphor tracer of a compound of formula MgAlₓGe_{y}O₃:zPr³⁺ nanoparticles, where x+y=1, and z is 0.1-0.5% with light, and further injecting the nanophosphor tracer at a first location in a subterranean geological reservoir where the nanophosphor tracer mixes with a subsurface fluid in the subterranean geological reservoir. The method further includes collecting a fluid sample from a second location in the subterranean geological reservoir and analyzing the fluid sample to detect the presence of the nanophosphor tracer in the fluid sample.

### STATEMENT OF PRIOR DISCLOSURE BY INVENTOR

Aspects of the present disclosure were presented at the ASCE Engineering Mechanics Institute 2023 Conference in a poster by S. Shah and S. Khan entitled “Multiband Red/NIR/SWIR synthesis of MgGeO₃:Pr³⁺”, incorporated herein by reference in its entirety.

### STATEMENT OF ACKNOWLEDGEMENT

Support provided by the King Fahd University of Petroleum and Minerals (KFUPM) is gratefully acknowledged.

### BACKGROUND

### Technical Field

The present disclosure is directed to persistent phosphors, more particularly, to MgAlₓGe_{y}O₃:zPr³⁺ persistent phosphors, which can be used as tracers in oil recovery applications.

### Description of Related Art

The “background” description provided herein is to present the context of the disclosure generally. Work of the presently named inventors, to the extent it is described in this background section, as well as aspects of the description that may not otherwise qualify as prior art at the time of filing, are neither expressly nor impliedly admitted as prior art against the present invention.

Persistent luminescence is a phenomenon in which the materials continuously emit light from minutes to hours after the stoppage of excitation. Persistent phosphors in the visible light range have been used in a variety of areas and have achieved commercial success. Recently, persistent luminescence in the near-infrared (NIR, 700-900 nm) and the short-wave infrared (SWIR, 900-1700 nm) has received considerable attention in biomedical imaging and night-vision surveillance. The important feature of persistent luminescence materials is their self-illuminating nature, which helps in excitation-free imaging in an autofluorescence-free manner, empowering a high signal-to-noise ratio and high sensitivity. There is an interest in the Pr³⁺ emission for various applications in display, lighting, security, and healthcare. The various intra-configurational transitions of 4f² states and other inter-configurational 4f¹5d¹ states of Pr³⁺ exhibit luminescence in UV, visible, NIR, and SWIR in different hosts, making it favorable for getting different colors and potential applications. The red emission from the ¹D₂ state of the Pr³⁺ has been used in vacuum fluorescent and field emission displays.

For enhanced oil recovery, reservoir characterization can be achieved using designed reservoir tracers. To get the reservoir information, two types of tracers, i.e., chemical, and radioactive tracers, have been utilized. Environmental concerns and the use of expensive analytical techniques limit the use of these tracers. The use of nanotechnology is promising for illuminating the reservoir. Recently, carbon dots and rare-earth-doped nanoparticles (NPs) have been used as tracers, and although they exhibit some advantages, they suffer from the lower sensitivity in crude oil, which is mainly from the autofluorescence from crude oil under constant external excitation. The poor detection limit also limits its use for practical applications. To suppress the autofluorescence from the oil samples, long-life-time fluorescence nanomaterials have been utilized. Thus, it is necessary to develop and use new tracers that are non-radioactive, stable in harsh reservoir environments, and can be used in standard labs.

To overcome the above shortcomings, the use of persistent luminescence NPs is advantageous. As the persistent luminescence materials are excited, the stored energy by the electrons is captured by the traps in the materials, which are gradually released to the emitting center in the materials over long periods of time after the initial excitation. The prolonged luminescence limits the need for constant external excitation, thereby limiting autofluorescence from the crude oil itself. The low detection limit, flexibility and ease of detecting the luminescence of the persistent phosphors are also reasons to use multiband persistent luminescence nanomaterials that emit visible, near-infrared (NIR), and shorter wave infrared (SWIR) regions.

Persistent luminescence materials are synthesized using different methodologies but are mostly synthesized by solid-state methods, which result in large particle sizes and passive surfaces. The preparation method greatly influences the properties of the phosphor. Compositional inhomogeneity, high processing temperature, and non-uniformity in particle sizes hinder the mixed oxides route of preparation for nanophosphors.

Although fluorescent nanoparticles for tracing in oil reservoirs have been developed in the past, these fluorescent nanoparticles suffer from background interferences under constant external excitation from the organic residues in the crude oil. This results in insufficient sensitivity and an inferior tracer detection limit in the crude oil/water emulsions. Accordingly, an object of the present disclosure is to develop persistent phosphors, which can be used as tracers in oil recovery applications.

### SUMMARY

In an exemplary embodiment, a method for reservoir characterization using a nanophosphor tracer is described. The method includes exciting a nanophosphor tracer with light, whereupon exciting the nanophosphor, the nanophosphor tracer emits light for at least 3 hours. The nanophosphor tracer includes MgAlₓGe_{y}O₃:zPr³⁺ nanoparticles, where x+y=1, and z is 0.1-0.5 at. %, relative to total number of atoms in the MgAlₓGe_{y}O₃:zPr³⁺ nanoparticles. The method further includes injecting the nanophosphor tracer at a first location in a subterranean geological reservoir where the nanophosphor tracer mixes with a sub-surface fluid in the subterranean geological reservoir. The method further includes collecting a fluid sample from a second location in the subterranean geological reservoir and analyzing the fluid sample to detect a presence of the nanophosphor tracer in the fluid sample.

In some embodiments, the method includes determining a subsurface fluid-flow pattern in the subterranean geological reservoir based on the presence of the nanophosphor tracer in the fluid sample.

In some embodiments, the method of analyzing the fluid sample includes acquiring a persistent luminescence spectrum of the fluid sample, wherein the step of acquiring does not include further exciting of the fluid sample.

In some embodiments, the method of analyzing the fluid sample includes acquiring a time-dependent persistent luminescence spectrum of the fluid sample, wherein the step of acquiring does not include further exciting of the fluid sample.

In some embodiments, the method of analyzing the fluid sample occurs up to 15 hours after the exciting.

In some embodiments, following the exciting, the nanophosphor tracer emits light having a wavelength of 600-650 nanometers (nm), 900-910 nm, and 1050-1100 nm.

In some embodiments, the nanophosphor tracer emits light having a wavelength of 600-650 nm for up to 15 hours, followed by exciting with 200-300 nm light.

In some embodiments, the MgAlₓGe_{y}O₃:zPr³⁺ nanoparticles have a formula of MgAl_{0.05}Ge_{0.95}O₃:0.3Pr³⁺.

In some embodiments, the MgAlₓGe_{y}O₃:zPr³⁺ nanoparticles have an orthorhombic crystal structure.

In some embodiments, the MgAlₓGe_{y}O₃:zPr³⁺ nanoparticles have an average size of 10-500 nm.

In some embodiments, the MgAlₓGe_{y}O₃:zPr³⁺ nanoparticles have a concentration of 1-1,000 parts per billion (ppb), based on a total volume of the subsurface fluid.

In some embodiments, the method of exciting includes irradiating the nanophosphor tracer with ultraviolet (UV) light having a wavelength of 200-300 nm for at least 1 minute.

In some embodiments, the method of analyzing the fluid sample is in real-time at the second location.

In some embodiments, the method further includes repeating the collecting and the analyzing at 3-50 additional locations.

In some embodiments, the method further includes repeatedly exciting the nanophosphor tracer following the injecting inside of the subterranean geological reservoir.

In some embodiments, the subsurface fluid comprises at least one of natural gas, crude oil, connate water, or seawater.

In an exemplary embodiment, a method of preparing the MgAlₓGe_{y}O₃:zPr³⁺ nanoparticles is described. The method includes mixing an Al salt, Mg salt, GeO₂, and a Pr salt in solvent with a complexing agent to form a first mixture; dehydrating the first mixture to a temperature of 50-100° C. to form a polymeric complex; heating the polymeric complex for at least 10 hours at a temperature of 80-110° C. to form a foam; combusting the foam at a temperature of 400-600° C. to form a powder; and calcining the powder at a temperature of 500-1,000° C. to form the MgAlₓGe_{y}O₃:zPr³⁺ nanoparticles.

In some embodiments, a molar ratio of the Al salt, Mg salt, GeO₂, and a Pr salt to the complexing agent is 1 to 1-5.

The foregoing general description of the illustrative present disclosure and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1A is a flowchart depicting a method for reservoir characterization using a nanophosphor tracer, according to certain embodiments.

FIG. 1B is a flowchart depicting a method of making MgAlₓGe_{y}O₃:zPr³⁺ nanoparticles, according to certain embodiments.

FIG. 2 depicts X-ray diffraction (XRD) patterns of non-doped MgGeO₃: 0.3% Pr³⁺ (i-iii) and MgAl_{0.05}Ge_{0.95}O₃:0.3% Pr³⁺ (iv-vii) persistent phosphors synthesized by annealing at different temperatures (1000, 1100 and 1200° C.) for different times (30, 60, 90 and 120 minutes), according to certain embodiments.

FIG. 3A depicts persistent luminescence decay curves of MgAl_{0.05}Ge_{0.95}O₃:0.3% Pr³⁺ nanophosphors synthesized by annealing at different temperatures, monitored at 625 nanometers (nm), according to certain embodiments.

FIG. 3B depicts persistent luminescence decay curves of MgAl_{0.05}Ge_{0.95}O₃:0.3% Pr³⁺ nanophosphors synthesized by annealing at different temperatures, monitored at 905 nm, according to certain embodiments.

FIG. 3C depicts persistent luminescence decay curves of MgAl_{0.05}Ge_{0.95}O₃:0.3% Pr³⁺ nanophosphors synthesized by annealing at different temperatures, monitored at 1089 nm, according to certain embodiments.

FIG. 4A depicts a photoluminescence excitation spectrum of MgAl_{0.05}Ge_{0.95}O₃:0.3% Pr³⁺ persistent phosphor obtained by monitoring at 625 nm emission, according to certain embodiments.

FIG. 4B depicts a photoluminescence emission spectrum of MgAl_{0.05}Ge_{0.95}O₃:0.3% Pr³⁺ persistent phosphor obtained with a 260 nm excitation, according to certain embodiments.

FIG. 5A depicts a schematic of the energy levels of Pr³⁺ states in the conduction band (CB) and the valence bond (VB) of the MgAl_{0.05}Ge_{0.95}GeO₃: 0.3% Pr³⁺, according to certain embodiments.

FIG. 5B is a schematic diagram showing the configuration-coordinate of the preferential feeding of ¹D₂ state of Pr³⁺ by the exciton-like state, according to certain embodiments.

FIG. 6A shows persistent luminescence emission spectra of MgAl_{0.05}Ge_{0.95}O₃:0.3% Pr³⁺ persistent phosphor recorded at different decay times from 5 minutes to 5 hours, according to certain embodiments.

FIG. 6B shows persistent luminescence decay curves of MgAl_{0.05}Ge_{0.95}O₃:0.3% Pr³⁺ persistent phosphor obtained by monitoring at 625, 905, and 1088 nm for 1 hour after irradiation at 254 nm for 5 minutes, according to certain embodiments.

FIG. 6C shows a persistent luminescence decay curve of MgAl_{0.05}Ge_{0.95}O₃:0.3% Pr³⁺ persistent phosphor obtained by monitoring at 625 nm for 15 hours after irradiation at 254 nm for 5 min, according to certain embodiments.

FIG. 7 shows persistent luminescence emission spectra of MgAl_{0.05}Ge_{0.95}O₃:0.3% Pr³⁺ persistent phosphor recorded at different decay times from 5 minutes to 5 hours, according to certain embodiments.

FIG. 8A shows photoluminescence emission spectra of 1000 ppm MgAl_{0.05}Ge_{0.95}O₃:0.3% Pr³⁺ NPs dispersed in DI water, 50/50 crude oil/water emulsion, and 1000 ppm MgAl_{0.05}Ge_{0.95}O₃:0.3% Pr³⁺ NPs in 50/50 crude oil/water emulsion, under 260 nm excitation, according to certain embodiments.

FIG. 8B shows persistent luminescence emission spectra of 1000 ppm MgAl_{0.05}Ge_{0.95}O₃:0.3% Pr³⁺ NPs dispersed in DI water, 50/50 crude oil/water emulsion, and 1000 ppm MgAl_{0.05}Ge_{0.95}O₃:0.3% Pr³⁺ NPs in 50/50 crude oil/water emulsion, recorded after 1 minute of ceasing the excitation at 254 nm ultraviolet (UV) radiation, according to certain embodiments.

FIG. 9 shows persistent luminescence emission spectra of MgAl_{0.05}Ge_{0.95}O₃:0.3% Pr³⁺ persistent phosphor dispersed in water, recorded at different concentrations, according to certain embodiments.

FIG. 10 depicts persistent luminescence images in the visible range of 1000, 100, 50, 10, 5, 1, 0.5, and 0 ppb MgAl_{0.05}G_{0.95}O: 0.3% Pr³⁺ NPs in 50/50 (volume ratio) crude oil/water emulsions, according to certain embodiments.

### DETAILED DESCRIPTION

When describing the present disclosure, the terms used are to be construed in accordance with the following definitions, unless a context dictates otherwise.

Embodiments of the present invention will now be described more fully hereinafter with reference to the accompanying drawings wherever applicable, in that some, but not all embodiments of the disclosure are shown.

In the drawings, like reference numerals designate identical or corresponding parts throughout the several views. Further, as used herein, the words “a,” “an” and the like generally carry a meaning of “one or more,” unless stated otherwise.

Furthermore, the terms “approximately”, “approximate”, “about,” and similar terms generally refer to ranges that include the identified value within a margin of 20%, 10%, or preferably 5%, and any values therebetween.

Where a numerical limit or range is stated herein, the endpoints are included. Also, all values and subranges within a numerical limit or range are specifically included as if explicitly written out.

The use of the terms “include,” “includes”, “including,” “have,” “has,” or “having” should be generally understood as open-ended and non-limiting unless specifically stated otherwise.

As used herein, “nanoparticles” are particles having a particle size of 1 nm to 500 nm within the scope of the present invention.

As used herein, “luminescence” or “photoluminescence” is the spontaneous emission of radiation from an electronically excited species (or from a vibrationally excited species) not in thermal equilibrium with its environment. Generally, the emission of light is due to the movement of electrons between different energy levels within an atom after excitation by external factors.

As used herein, “persistent luminescence” or “phosphorescence” is a type of photoluminescence related to fluorescence. When exposed to light (radiation) of a shorter wavelength, a phosphorescent substance will glow, absorbing the light and reemitting it at a longer wavelength. Unlike fluorescence, a phosphorescent material does not immediately reemit the radiation it absorbs. Instead, a phosphorescent material absorbs some of the radiation energy and reemits it for a much longer time after the radiation source is removed.

As used herein, a “nanophosphor” is a nanoparticle which displays persistent luminescence.

As used herein a “tracer” refers a material used in the oil industry in order to qualitatively or quantitatively gauge how fluid flows through the reservoir. Tracers can be used in either interwell tests or single well tests. In interwell tests, the tracer is injected at one well along with the carrier fluid (e.g., water in a waterflood or gas in a gasflood) and detected at a producing well after some period of time, which can be anything from days to years. In single well tests, the tracer is injected into the formation from a well and then produced out the same well. Tracers can be radioactive or chemical, solid, gas or liquid.

As used herein, a “geological reservoir” or “reservoir” is a body of rock or geological formation having a subsurface accumulation of hydrocarbons contained in porous or fractured rock formations.

As used herein, a “borehole” refers to a shaft that is drilled into the geological formation, for purposes such as extracting water, petroleum or natural gas, or mineral exploration and other environmental investigations. An average depth of the borehole is from 100 to 5,000 m, preferably 500 to 4,500 m, 1,000 to 4,000 m, 1,500 to 3,500 m, or 2,000 to 3,000 m. The borehole is drilled in any suitable location wherein the geological formation has a suitable thickness. The borehole may be empty, e.g., contain only ambient atmospheric air, or may contain other fluids such as gaseous and/or liquid hydrocarbons and/or aqueous compositions such as freshwater, salt water, seawater or formation water.

As used herein, an “injection well” or “well” is a device that places fluid deep underground into a rock formation. The injection well can be installed into the borehole to inject the liquid. For example, the liquid of the present disclosure includes the nanophosphor tracer. The injection well may be present mainly on the surface outside the borehole or may be fully or partially disposed inside the borehole. For example, pressurization equipment used to pressurize one or more fluids for injection into the borehole may be located outside the well preferably connected to a wellhead that is mainly outside the borehole. Other elements of an injection well such as a bore tube are preferably disposed mainly in the borehole, e.g., extending downwards into the borehole for a distance and may include devices such as packers to form a seal inside the borehole.

A nanophosphor tracer, also referred to as the nanoparticles, is described. The nanophosphor tracer includes MgGeO₃ as a host material. In some embodiments, the MgGeO₃ is doped with at least one first element selected from the group consisting of aluminum (Al), silicon (Si), gallium (Ga), zinc (Zn), copper (Cu), nickel (Ni), cobalt (Co), iron (Fe), manganese (Mn), chromium (Cr), cadmium (Cd), tin (Sn), and antimony (Sb). In a preferred embodiment, the first element is Al, where the Al is Al(I), Al(II), or Al(III). In some embodiments, the Al replaces a portion of the Ge atoms in the MgGeO₃, therefore the nanophosphor tracer has a formula of MgAlₓGe_{y}O₃ where x+y=1. In some embodiments, the first element is included in an amount of 0.01-99 mol %, preferably 0.1-90 mol %, 1-80 mol %, 10-70 mol %, or 40-60 mol % relative to a total amount of the first element and the germanium (Ge) in the MgGeO₃.

In some embodiments, the MgGeO₃ is doped with the first element and at least second one element selected from the group consisting of lanthanum (Ln), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), lutetium (Lu), and praseodymium (Pr). In a preferred embodiment, the second element is Pr, where the Pr is Pr³⁺. In some embodiments, the second element is included in an amount of 0.1-10 at %, preferably 0.5-9 at %, 1-8 at %, 2-7 at %, 3-6 at %, or 4-5 at % relative to a total amount of atoms in the nanoparticles.

In a most preferred embodiment, the nanophosphor tracer includes MgAlₓGe_{y}O₃:zPr³⁺ nanoparticles, where x+y=1, and z is in a range of 0.1-0.5%. In an embodiment, ‘x’ is in the range of 0.01 to 0.99, preferably 0.02 to 0.9, preferably 0.03 to 0.8, preferably 0.035 to 0.6, preferably 0.04 to 0.4, preferably 0.05 to 0.1, more preferably about 0.05. In an embodiment, ‘y’ is in the range of 0.01 to 0.99, preferably 0.1 to 0.98, preferably 0.2 to 0.97, preferably 0.3 to 0.96, preferably 0.5 to 0.95, preferably 0.5, 0.55, 0.6, 0.65, 0.7, 0.75, 0.8, 0.85, 0.9, and more preferably about 0.95. In an embodiment, z is 0.1, 0.2, 0.3, 0.4, or 0.5, preferably 0.3, and refers to an atomic percent based on a total number of atoms in the nanoparticles. In a preferred embodiment, the MgAlₓGe_{y}O₃:zPr³⁺ nanoparticles have a formula of MgAl_{0.05}Ge_{0.95}O₃:0.3Pr³⁺.

In some embodiments, the MgAlₓGe_{y}O₃:zPr³⁺ nanoparticles have triclinic, monoclinic, orthorhombic, tetragonal, trigonal, hexagonal, or cubic crystal structure. In some embodiments, the MgAlₓGe_{y}O₃:zPr³⁺ nanoparticles have an orthorhombic crystal structure. In some embodiments, the MgAlₓGe_{y}O₃:zPr³⁺ nanoparticles have various morphological shapes, such as nanowires, nanocrystals, nanorectangles, nanosheets, nanotriangles, nanopentagons, nanohexagons, nanoprisms, nanodisks, nanocubes, nanoribbons, nanoblocks, nanobeads, nanotoroids, nanodiscs, nanobarrels, nanogranules, nanowhiskers, nanoflakes, nanofoils, nanopowders, nanoboxes, nanostars, tetrapods, nanobelts, nano-urchins, nanoflowers, etc. and mixtures thereof. In some embodiments, the MgAlₓGe_{y}O₃:zPr³⁺ nanoparticles have varied particle sizes of 10, 20, 30, 40, 50, 60, 70, 80, 90, 100, 120, 140, 160, 180, 200, 220, 240, 260, 280, 300, 320, 340, 360, 380, 400, 420, 440, 460, 480, 500 nm, with the average size of the MgAlₓGe_{y}O₃:zPr³⁺ nanoparticles in the range of 10-500 nm.

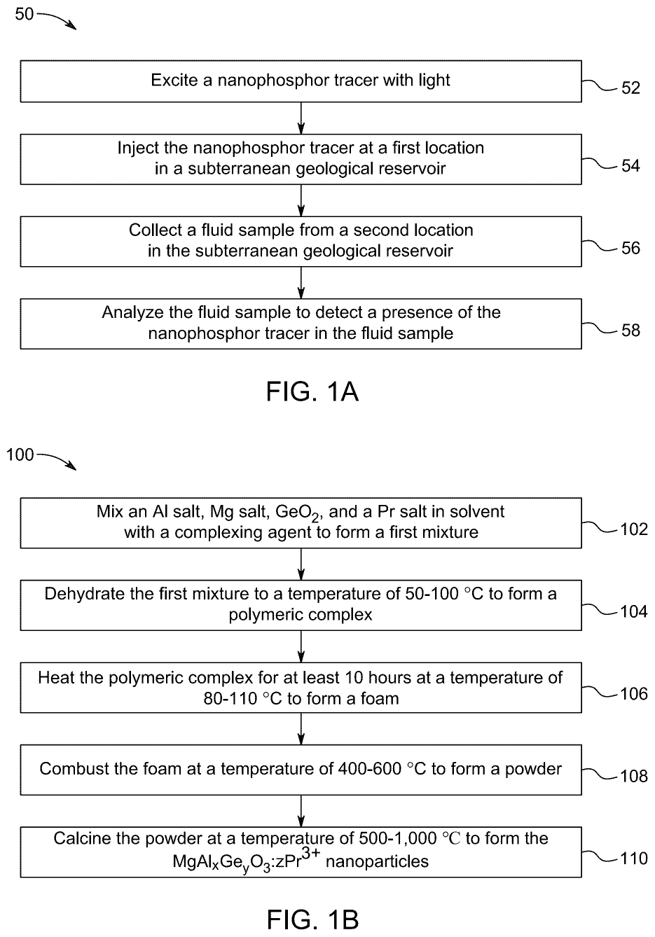

FIG. 1A illustrates a flow chart of a method 50 for determining a fluid flow pattern in a subterranean geological reservoir using a nanophosphor tracer. The order in which the method 50 is described is not intended to be construed as a limitation, and any number of the described method steps can be combined in any order to implement the method 50. Additionally, individual steps may be removed or skipped from the method 50 without departing from the spirit and scope of the present disclosure.

At step 52, the method 50 includes exciting a nanophosphor tracer with light. In some embodiments, the nanophosphor tracer may be dissolved in a suitable solvent prior to excitation. It is generally preferred to choose a solvent that offers a high degree of solubility in fluids that naturally occur and circulate in reservoirs (for example, water or hydrocarbon compounds) and a relatively weak affinity for the various bedrock and earth formations that the tracers are exposed to while moving through the reservoir. In an embodiment, the solvent is water. In some embodiments, the solvent is an oil, preferably a crude oil, or a mixture of oil and water. Optionally, other oils known in the art may be used as well.

After dissolving the nanophosphor tracer in a suitable solvent, the nanophosphor tracer is excited by irradiating the nanophosphor tracer with light having a wavelength of 200-300 nm, preferably 205-300 nm, preferably 210-300 nm, preferably 220-300 nm, preferably 230-300 nm, preferably 240-300 nm, preferably 240 nm, preferably 250 nm, preferably 260 nm, preferably 270 nm preferably 280 nm, preferably 290 nm, and more preferably 240-260 nm, and yet more preferably 250-254 nm for at least 1 minute, preferably 2 minutes, preferably 3 minutes, preferably 4 minutes, and more preferably for 5 minutes. However, in some embodiments, the nanophosphor tracer may be excited at higher wavelengths in a range of 300-700 nm, preferably 400-650 nm, preferably 400-600 nm, preferably 430-500 nm for at least 1 minute, preferably 2 minutes, preferably 3 minutes, preferably 4 minutes, and more preferably for 5 minutes. In some embodiments, the excitation by irradiation at the suggested wavelengths may be carried out in periodic regular/irregular intervals—for example, the irradiation may be carried out after every 10 seconds, 15 seconds, 30 seconds, 45 seconds, 1 minute, 2 minutes, 3 minutes, etc. In an embodiment, the nanophosphor tracer is irradiated by ultraviolet (UV) light.

At step 54, the method 50 includes injecting the nanophosphor tracer at a first location in a subterranean geological reservoir (also referred to as the reservoir). The nanophosphor tracer is injected into the first location (or an injection well) in the reservoir. Inside the reservoir is a subsurface fluid. The subsurface fluid includes at least one of natural gas, crude oil, connate water, and seawater. The nanophosphor tracer can mix with the subsurface fluid under the first location. For example, the nanophosphor tracer can diffuse into the fluid or mix with the fluid due to advection. In some embodiments, the MgAlₓGe_{y}O₃:zPr³⁺ nanoparticles have a concentration of 1-1,000 parts per billion (ppb), preferably 100-900 ppb, 200-800 ppb, 300-700 ppb, or 400-600 ppb, based on a total volume of the subsurface fluid. In some embodiments, the amount of MgAlₓGe_{y}O₃:zPr³⁺ nanoparticles injected is based on such concentrations.

The subsurface fluid including the nanophosphor tracer, may take various pathways/patters inside the reservoir. Inside the reservoir, the nanophosphor tracer emits light with wavelengths of 600-650 nm, 900-910 nm, and 1050-1100 nm, preferably 610-640 nm, 902-908 nm, 1060-1090 nm, and more specifically, 625 nm, 905 nm, and 1089 nm. The nanophosphor tracer imparts persistent luminescence properties where it emits light for at least 3 hours, preferably 3-15 hours after excitation, 4-14 hours, 5-13 hours, 6-12 hours, 7-11 hours, or 8-10 hours. In a specific embodiment, the nanophosphor tracer emits light having a wavelength of 600-650 nm, preferably 610-640 nm, preferably 620-630 nm, preferably 625 nm, for up to 15 hours following excitation with 200-300 nm light.

At step 56, the method 50 includes collecting a fluid sample from a second location in the subterranean geological reservoir. The second location is the location from which the fluid sample is extracted or collected from the reservoir (also referred to as a point of extraction). In an embodiment, the fluid sample collected from the second location may include, in addition to the nanophosphor tracer, materials and compounds typically found in the earth's crust, for example, water, heavy metals (for example, iron, manganese, chromium, vanadium, or zirconium), salts (for example, potassium salts, calcium salts, magnesium salts, or sodium salts (for example, sodium chloride)), naturally occurring radioactive material (for example, uranium, thorium, radium, or radon), zinc, lead, sulfur, barium, or any combination thereof. In some embodiments, the fluid sample includes hydrocarbons (for example, hydrocarbons derived from various forms of petroleum including, but not limited to, paraffinic petroleum, paraffinic-naphthenic petroleum, naphthenic petroleum, paraffinic-naphthenic-aromatic petroleum, and aromatic petroleum) and polyaromatic hydrocarbons. In some embodiments, the fluid sample collected from the second location may be purified before analysis to eliminate spectral contributions from the other components (that is, “background noise”) during measurement. In some embodiments, the fluid sample may be collected from multiple locations, for example, at least 3-50 locations, preferably 5-45, 10-40, 15-35, or 20-30 locations. Collecting the fluid sample at multiple locations helps to determine the fluid flow pattern and specifically the well contributing towards hydrocarbon production.

At step 58, the method 50 includes analyzing the fluid sample to detect a presence of the nanophosphor tracer in the fluid sample. The fluid sample from the second location is analyzed to detect the presence of the nanophosphor tracer. The presence of the nanophosphor tracer at the point of extraction/second location is indicative of a connection existing between the point of injection (the first location) and the point of extraction (the second location) and, if connected, can also indicate how fluid flows through the reservoir. For example, if the nanophosphor tracer is introduced into the first location and subsequent sample extraction from the second location shows the presence of the nanophosphor tracer, a connection exists between the point of injection and the point of extraction. The luminescence imparted by the nanophosphor tracer is captured by well-known imaging techniques known in the art such as but not limited to a spectrofluorometer or a cooled charge-coupled device (CCD) camera.

The method may further include determining a subsurface fluid-flow pattern in the subterranean geological reservoir based on the presence of the nanophosphor tracer in the fluid sample. The fluid flow pattern within the reservoir is determined based on the detected luminescence emitted by the nanophosphor.

In some embodiments, the method of analyzing the fluid sample includes acquiring a persistent luminescence spectrum of the fluid sample, wherein the step of acquiring does not include further exciting of the fluid sample. The persistent luminescence spectrum shows the presence of the nanophosphor tracer in the fluid sample and if the sample is analyzed within the timeframe of the persistent luminescence of the nanophosphor tracer (i.e., within 15 hours at 600-650 nm) the sample does not need to be re-excited. Without the need for re-excitation, there is less background noise imparted by the photoluminescence of the components of the oil (such as aromatic compounds) and provides a more accurate and higher sensitivity analysis.

In some embodiments, the method of analyzing the fluid sample includes acquiring a time-dependent persistent luminescence spectrum of the fluid sample, wherein the step of acquiring does not include further exciting of the fluid sample. The time-dependent persistent luminescence spectrum shows the presence of the nanophosphor tracer in the fluid sample and if the sample is analyzed within the timeframe of the persistent luminescence of the nanophosphor tracer (i.e., within 15 hours at 600-650 nm) the sample does not need to be re-excited. Without the need for re-excitation, there is less background noise imparted by the photoluminescence of the components of the oil (such as aromatic compounds) and provides a more accurate and higher sensitivity analysis. However, unlike the persistent luminescence spectrum the time-dependent persistent luminescence spectrum can provide insight into the length of time required for the nanophosphor tracer to reach the extraction location. For example, when the nanophosphor tracer is injected at the first location and then extracted at the second location, the amount of time left in the photoluminescence of the nanophosphor determined from the time-dependent persistent luminescence spectrum, gives insight in how long it took to arrive at the second location. As an example, the elapsed time between injection and the appearance of the tracer in the extracted fluid can provide information about the fluid flow capacity of the reservoir, the interconnected-ness of flow pathways, and residual oil saturation, which is difficult to acquire directly by other means.

The method of the present disclosure allows for real-time or near real-time characterization of the reservoirs. This process is repeated for all the samples collected from each second location. In some embodiments, the analysis process can occur up to 15 hours after the excitation process, as the nanophosphor tracer has persistent luminescence up to 15 hours between 600-650 nm. In some embodiments, to extend the time period for the analysis, the nanophosphor tracer may be repeatedly excited by irradiation at the wavelength ranges as described earlier, following the injection of the nanophosphor inside the subterranean geological reservoir.

Referring to FIG. 1B, a method 100 of making MgAlₓGe_{y}O₃:zPr³⁺ nanoparticles is described. The order in which the method 100 is described is not intended to be construed as a limitation, and any number of the described method steps can be combined in any order to implement the method 100. Additionally, individual steps may be removed or skipped from the method 100 without departing from the spirit and scope of the present disclosure.

At step 102, the method 100 includes mixing an Al salt, Mg salt, GeO₂, and a Pr salt in a solvent with a complexing agent to form a first mixture. Suitable examples of Al salt include, but are not limited to, aluminum chloride, aluminum bromide, aluminum iodide, aluminum fluoride, aluminum nitrate, aluminum acetate, aluminum formate, aluminum sulphate, and/or combinations thereof. In a preferred embodiment, the Al salt is Al nitrate. Suitable examples of magnesium salt include, but are not limited to, magnesium hydroxide, magnesium sulphate, magnesium carbonate, magnesium citrate, magnesium trisilicate, magnesium nitrate, magnesium nitrite, magnesium acetate, magnesium formate, and/or combinations thereof. In a preferred embodiment, the magnesium salt is magnesium nitrate. Suitable examples of the Pr salt include, but are not limited to, PrF₃, PrCl₃, Pr(NO₃)₃, and Pr(CH₃COO)₃. In a preferred embodiment, the Pr salt is Pr(NO₃)₃. In some embodiments, the salts of other rare-earth lanthanides, such as lanthanum, ytterbium, europium, lanthanum, cerium, rubidium, caesium, niobium, tantalum, tellurium, terbium, lanthanum, gold, iridium, osmium, silver, platinum, palladium, rhenium, ruthenium, rhodium, hafnium, and/or indium, may be used in combination with the Pr salt to form the first mixture. The Al salt, Mg salt, GeO₂, and Pr salt are mixed in a solvent. The solvent may be an organic or an aqueous solvent. In an embodiment, the solvent is water. Suitable examples of the complexing agents include, but are not limited to, citric acid, lactic acid, nitriloacetic acid, ethylene diamine acetic acid (EDTA), etc. In a preferred embodiment, the complexing agent is citric acid. The molar ratio of the Al salt, Mg salt, GeO₂, and a Pr salt to the complexing agent is 1 to 1-5, preferably 1 to 1:4, preferably 1 to 1:3, preferably 1 to 1:2, preferably 1:2.

At step 104, the method 100 includes dehydrating the first mixture to a temperature of 50-100° C., preferably 50-90° C., preferably 50-80° C., preferably 50-70° C., preferably 50-60° C., preferably 60° C., to form a polymeric complex.

At step 106, the method 100 includes heating the polymeric complex for at least 10 hours, preferably between 10-14 hours, at a temperature of 80-110° C., preferably 90-100° C. to form a foam.

At step 108, the method 100 includes combusting the foam at a temperature of 400-600° C., preferably at about 500° C. to form a powder.

At step 110, the method 100 includes calcining the powder at a temperature of 500-1,500° C., preferably at about 1000° C., 1100° C., or 1200° C. for 30-120 minutes, preferably 60 mins to form the MgAlₓGe_{y}O₃:zPr³⁺ nanoparticles. In a preferred embodiment, the MgAlₓGe_{y}O₃:zPr³⁺ nanoparticles are calcined at 1200° C. for 60 min.

While not wishing to be bound to a single theory, it is thought that the co-doping of both Al and Pr along with the unique synthetic method, results in a nanophosphor with large amounts of defects and extended persistent luminescence. The high temperature calcining causes the formation of intrinsic defects but results in large sizes of the materials. The ionic radius of Al³⁺ as a co-doping ion is 0.675 Å, which substitutes the Ge⁴⁺ ion (0.67 Å) sites in hexacoordination in the MgGeO₃ lattice, which increases the number of lattice defects because the trivalent Al³⁺ ions occupy the tetravalent Ge⁴⁺ sites. The charge mismatch between these ions leads to spontaneous defect creation for charge compensation. Thus, the defects created by Al³⁺ doping could be the potential electron trapping center during persistent luminescence.

### EXAMPLES

The following examples demonstrate methods for reservoir characterization using a nanophosphor tracer, as described herein. The examples are provided solely for illustration and are not to be construed as limitations of the present disclosure, as many variations thereof are possible without departing from the spirit and scope of the present disclosure.

### Example 1: Chemicals

GeO₂ (99.999%) was purchased from GFI, Advanced Technologies, Inc. USA. Al(NO₃)₃·9H₂O (98.0-102%), NH₄OH (28% NH₃), MgO (99.99%), and Pr(NO₃)₃·6H₂O (99.99%) were purchased from Alfa Aesar, ThermoFisher (Kandel) GmbH, Germany. HNO₃ (69%) was purchased from Loba Chemie Pvt. Ltd., Mumbai, India. The citric acid (>99.5%) was obtained from Honeywell International India Pvt. Ltd. India. All the solutions were prepared in deionized (DI) water.

### Example 2: Synthesis of MgAl_{0.05}Ge_{0.95}O₃:0.3% Pr³⁺ Nanophosphor

The MgAl_{0.05}Ge_{0.95}O₃·0.3% Pr³⁺ phosphor was synthesized by a citrate sol-gel method with subsequent calcination. The amount of Pr is expressed in atomic percent (at. %) relative to the total atoms in the MgAlₓGe_{y}O₃:zPr³⁺ phosphor. The corresponding nitrates of the metals were dissolved in DI water, and citric acid was used as a complexing agent. Briefly, the stoichiometric amount of GeO₂ was added to 20 mL of deionized (DI) water. NH₄OH was added to it, followed by the addition of MgO. The MgO was converted to its nitrate form by the addition of HNO₃. Pr(NO₃)₃ was added to the above mixture, followed by the addition of Al(NO₃)₃. Lastly, citric acid was added to the reaction mixture. The molar ratio of metal cations to citric acid was 1:2. The solution mixture was stirred and heated at 60° C. The solution was then dehydrated at 95° C. to form a polymeric complex. The sample was then kept in the oven overnight at 95° C. to form foam with enormous swelling. The sample was then combusted on a hot plate at 500° C. to form a fine black powder. The powder was then ground in a mortar, transferred to ceramic crucibles, and calcined at various temperatures at different times, including 1200° C. for 60 min, 1100° C. for 90 min, 1000° C. for 120 min, and 1000° C. for 30 min.

MgGeO₃: 0.3% Pr³⁺ was also produced by the same method but without doping with Al as a comparative example. The MgGeO₃: 0.3% Pr³⁺ was calcined at various temperatures at different times, including 1200° C. for 60 min, 1000° C. for 60 min, and 1000° C. for 30 min.

The size of the particle was refined through grinding in a MICROCER grinder from NETZSCH Micro & Mini-Serie (2801047-10), Feinmahltecnik GmbH. The MgAl_{0.05}Ge_{0.95}O₃·0.3% Pr³⁺ particles were ground for 3 h in different solvents. The bigger particles can be removed by centrifuging at lower rotations. The particles were freeze-dried by Millrock Bench-Top Freeze-Dryer. The size and distribution of the as-synthesized MgAl_{0.05}Ge_{0.95}O₃:0.3% Pr³⁺ NPs were checked by the Zetasizer Nano-ZS, Malvern, UK.

### Example 3: Spectral Characterization Techniques

The spectral characterizations were done on a Horiba NanoLog spectrofluorometer set up with a 75 W xenon arc lamp and an R928 photomultiplier tube (PMT) and LN2-cooled InGaAs (DSS-IGA020L) detector. The photoluminescence excitation and emission spectra, persistent luminescence emission spectra, and persistent luminescence decay curves were acquired. The spectra analysis from 300 to 850 nm was done by using a photomultiplier tube (PMT) detector, while the liquid nitrogen cooled InGaAs detector was used for measurement from 850 to 1550 nm. For persistent luminescence spectra and decay curves, the samples were excited by using a 254 nm ultraviolet (UV) lamp. To avoid stray light in the spectral measurements, appropriate optical filters were used.

### Example 4: Detection of MgAl_{0.05}Ge_{0.95}O₃:0.3% Pr³⁺ NPs in Oil/Water Emulsion Techniques

The unrefined crude oil from Saudi Arabia was used without any pre-treatment. Different amounts of MgAl_{0.05}G_{0.95}O₃:0.3% Pr³⁺ dispersed in the water were mixed with the crude oil in a 50/50 volume ratio or otherwise specified to form the emulsions. 3.5 mL, 10 mm path-length quartz cuvettes were used for measurements. The spectral acquisition of the samples was done using the Horiba NanoLog spectrofluorometer.

The imaging of the samples was performed on an IVIS Lumina III imaging system (PerkinElmer) equipped with a cooled charge-coupled device (CCD) camera in the bioluminescence mode. The samples containing MgAl_{0.05}G_{0.95}O₃:0.3% Pr³⁺ NPs/water/crude oil in the quartz cuvettes were irradiated by a 254 nm UV light for 5 min. The images were taken after 15 seconds, 30 seconds, and 1 minute of the stoppage of excitation. Different exposure times for the images, i.e., 30 seconds and 1 minute, were taken. The images were processed by living image software (Version 4.7.2, PerkinElmer, Inc.). The images were taken under similar conditions for comparison. The average intensity was found by processing the obtained images by Living Image software at a binning of 8 and smoothing of 3×3 by the region of interest (ROI) tool.

### Example 5: Characterization of the MgAl_{0.05}Ge_{0.95}O₃:0.3% Pr³⁺ Nanophosphor

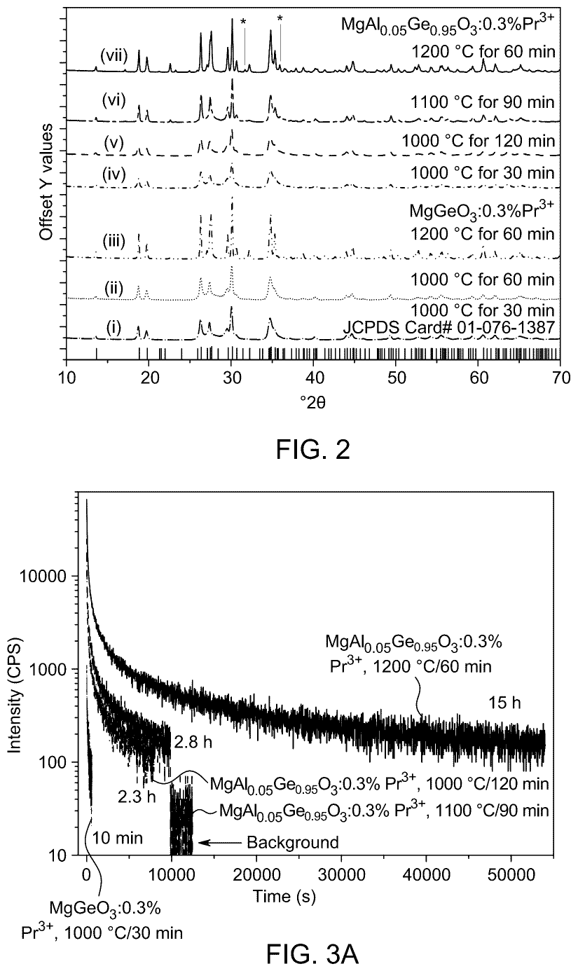

FIG. 2 depicts X-ray diffraction (XRD) patterns of non-doped MgGeO₃:0.3% Pr³⁺ (i-iii) and MgAl_{0.05}Ge_{0.95}O₃:0.3% Pr³⁺ (iv-vii) persistent phosphors synthesized by annealing at different temperatures (1000, 1100 and 1200° C.) for different times (30, 60, 90 and 120 minutes). The (vii) MgAl_{0.05}Ge_{0.95}O₃:0.3% Pr³⁺ synthesized at 1200° C. for 60 mins displays new peaks as shown by the * in FIG. 2. The synthesized phosphor has an orthorhombic (ilmenite) structure, as shown by the X-ray diffraction (XRD) measurements (FIG. 2). The doping of Pr³⁺ and Al³⁺ does not change the orthorhombic structure of the MgGeO₃ host material.

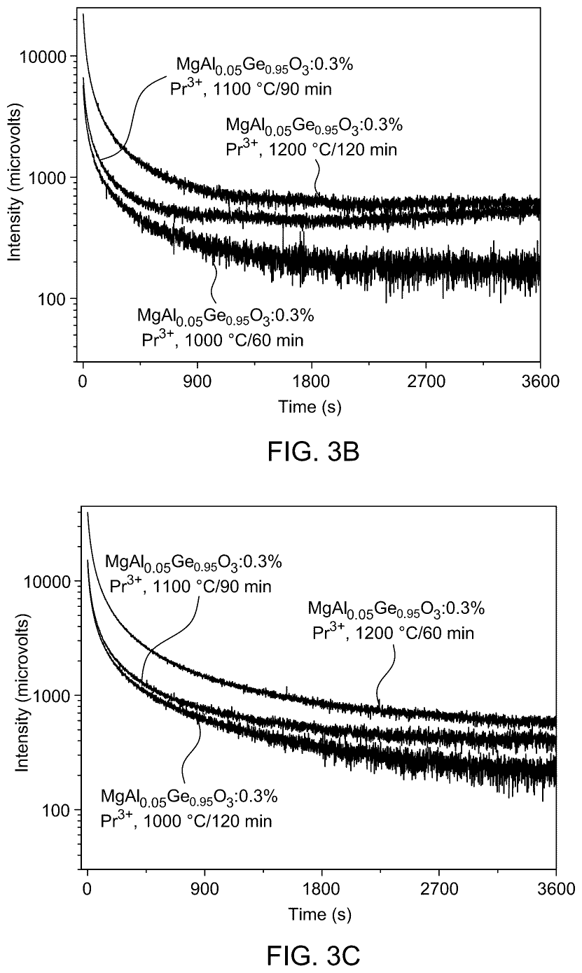

The persistent luminescence intensity and the persistent luminescence decay time of the synthesized phosphor were increased by co-doping with Al³⁺ with the Pr³⁺. The preferred amount of Al³⁺ was found to be 5 mol %. The persistent luminescence properties also increase with the increase in annealing temperature. The high temperature causes the formation of intrinsic defects but results in large sizes of the materials. The undoped MgGeO₃:Pr³⁺ sample has very poor persistent luminescence possession, which was greatly increased by the doping of the Al³⁺ ion (FIGS. 3A-3C). The ionic radius of Al³⁺ as a co-doping ion is 0.675 Å, which substitutes the Ge⁴⁺ ion (0.67 Å) sites in hexacoordination in the MgGeO₃ lattice. The Al³⁺ as a co-dopant increases the number of lattice defects because the trivalent Al³⁺ ions occupy the tetravalent Ge⁴⁺ sites. The charge mismatch between these ions leads to spontaneous defect creation for charge compensation. Thus, the defects created by Al³⁺ doping could be the potential electron trapping center during persistent luminescence in MgAl_{0.05}Ge_{0.95}O₃:0.3% Pr³⁺ NPs, which significantly enhanced the persistent luminescence of Pr³⁺ in the MgGeO₃ host. This explains the high persistent luminescence of the materials by co-doping with Al³⁺ ions. The MgAl_{0.05}Ge_{0.95}O₃:0.3% Pr³⁺ produced by calcining at 1200° C. for 60 min was found to have the longest persistent luminescence, therefore, it is used in all subsequent experiments.

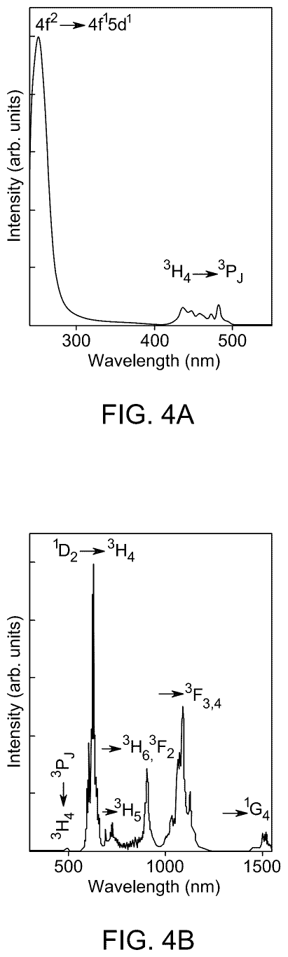

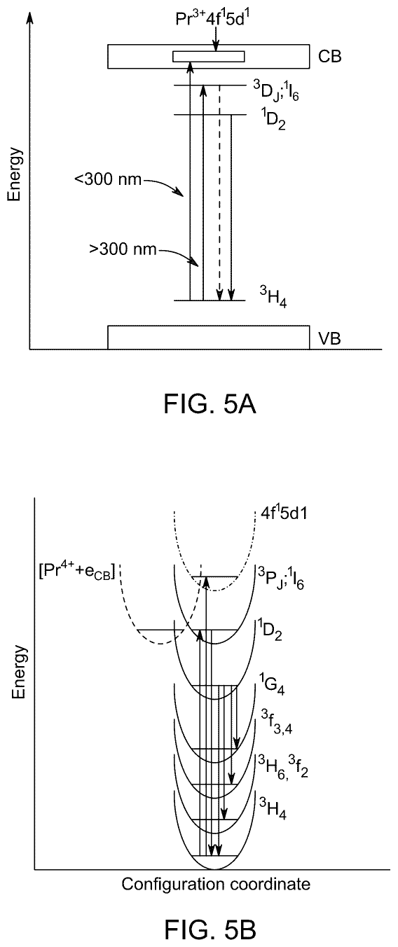

The photoluminescence excitation and emission spectra of the synthesized phosphor were carried out and the results are shown as normalized graphs in FIG. 4A & FIG. 4B. The excitation spectrum (monitored at 625 nm) covers the blue spectral region from 430 to 500 nm and the UV region (<300 nm). The excitation in the UV region (240-300 nm), peaking at 250 nm is due to the absorption of the host edge or due to the interconfigurational transition, 4f²→4f¹5d¹. The excitation peaks in the blue region (430 to 500 nm) are due to the intraconfigurational transition of an electron from the ground state (³H₄) to the ³P_{J} excited states of the Pr³⁺ ions. When the sample was excited at 260 nm, the samples were reported to show the emission in visible, NIR, and SWIR regions. There were three dominant peaks with some small peaks as well in the emission spectrum. A smaller peak at 430-500 nm was due to the ³P_{J}→³H₄ transition. In the emission spectrum of MgAl_{0.05}Ge_{0.95}O₃:0.3% Pr³⁺, the emissions were dominated by the transition from the ¹D₂ state of the Pr³⁺ (FIG. 4A). There was a red emission band peaking at 625 nm in the visible region from the ¹D₂→³H₄ transition of the Pr³⁺ ion. The peak at 905 nm in the NIR region was attributed to the ¹D₂→³H₆, ³F₂ transition, and the peak at 1089 nm was attributed to the emission from the ¹D₂→³F_{3,4} transition in the SWIR region. The peak at 1500 nm was due to the ¹D₂→¹G₄ transition (FIG. 4B). The dominance emission from the ¹D₂ state and the absence of the emission from the ³P_{J} state indicates the localization of the ⁴f¹5d¹ state of Pr³⁺ be in the conduction band of the host material and the emission must involve the trapped exciton-like, [Pr⁴⁺+e_{CB}], state. The excitation results in an electron from the ³H₄ state to the 4f¹5d¹ state (Eq. 1) and a subsequent transfer to the conduction band of the host to form an exciton-like state. The exciton-like state bypasses the ³P_{J} state and funnels the energy to the ¹D₂ (Eq. 2), which causes the preferential emission from the ¹D₂ state as explained in FIG. 5A and FIG. 5B. The 4f¹5d¹ state is non-radiatively quenched by the exciton like state, which results in no emission from 4f¹5d¹ to 4f² as shown in the simplified configuration coordinate scheme. The presence of metals in the host with nd⁰ or nd¹⁰ (e.g., Ge⁴⁺) configurations with metal-to-metal charge transfer transition also account for the no emission from the ³P_{J} state. Thus, the dominating emission from the ¹D₂ state of the Pr³⁺ is reasonable.

4f²(³H₄)→4f¹5d¹; ³P_{J[=0,1,2]} Eq. 1

4f¹5d¹→¹D₂ Eq. 2

In the dispersion of MgAl_{0.05}Ge_{0.95}O₃:0.3% Pr³⁺ in an aqueous medium, the 4f¹5d¹ state of Pr³⁺ localized below the conduction band. The excited electron moves to lower energy level, and then there is a weak emission from 3P0 state. The 4f¹5d¹ state now feeds the ³P_{J} state in the absence of an exciton-like state. So, the emission from the ³P_{J} state is also observed.

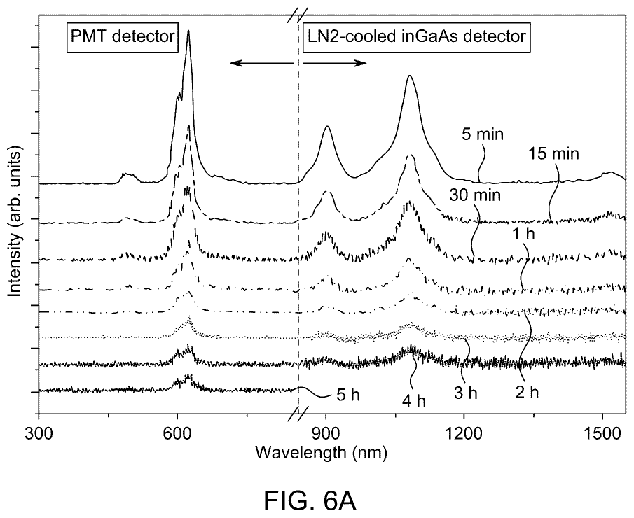

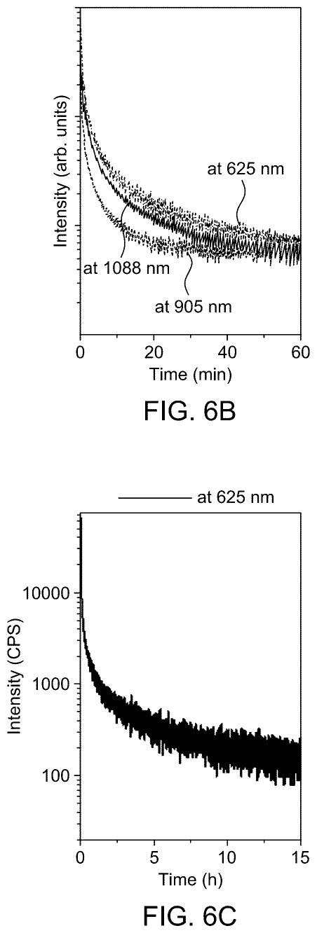

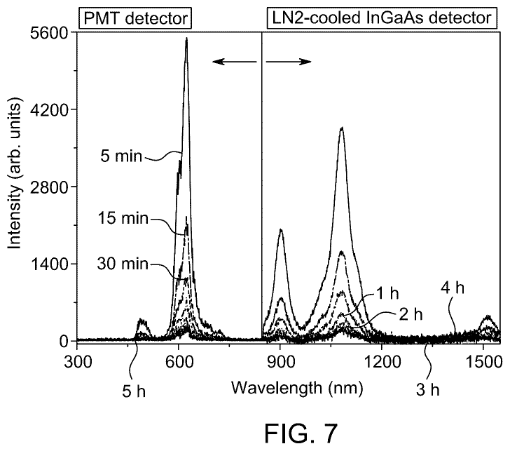

When the sample was excited at 254 nm under UV light for 5 minutes and then irradiation was ceased, the persistent luminescence in the visible, NIR, and SWIR regions was observed in the synthesized phosphor (FIG. 6A-6C). The persistent luminescence emission spectra were recorded at different decay times (from 5 min to 5 h) after the excitation of the samples at 254 nm for 5 min (FIG. 6A). From the spectra, the persistent luminescence signal was recorded in the visible, NIR, and SWIR regions after 5 h. The persistent luminescence emission spectra (FIG. 7) are identical to the photoluminescence spectra of the synthesized solid-state phosphor, showing that the emission in all the regions is from the same emitting state (¹D₂) of the Pr³⁺ ions. The persistent luminescence decay curves at different wavelengths i.e., 625, 905, and 1089 nm were recorded for 1 h (FIG. 6B). The persistent luminescence decay curve of the spin forbidden ¹D₂→³H₄ transition at 625 nm can be monitored for more than 15 h after the stoppage of the excitation (FIG. 6C). Mechanistically, the excitation in the UV region caused the photogenerated electron, which can be captured and stored by the traps in the host. When the excitation was stopped, owing to thermal stimulation these stored electrons escaped back to the excited state of the Pr³⁺ ions and resulted in persistent luminescence in the visible, NIR, and SWIR regions.

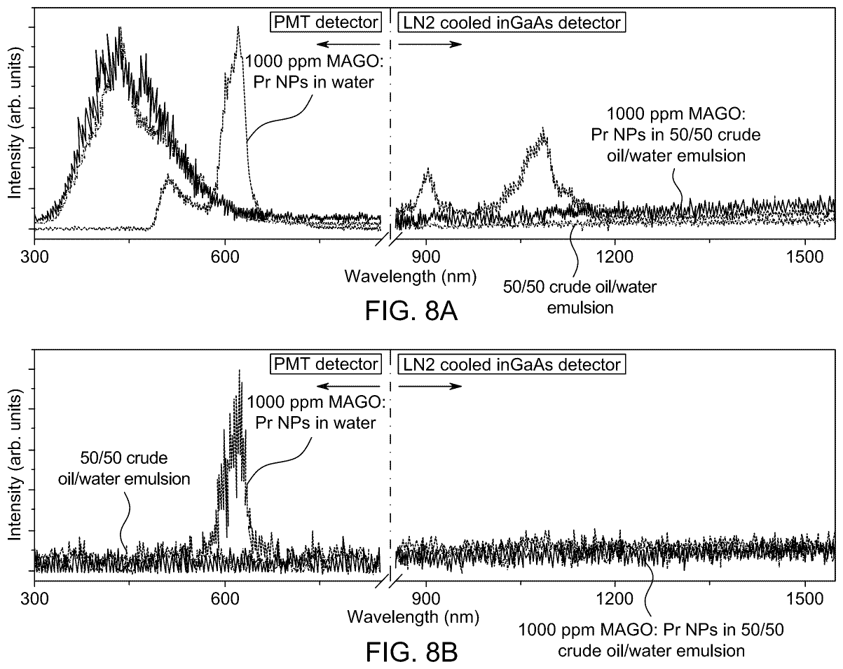

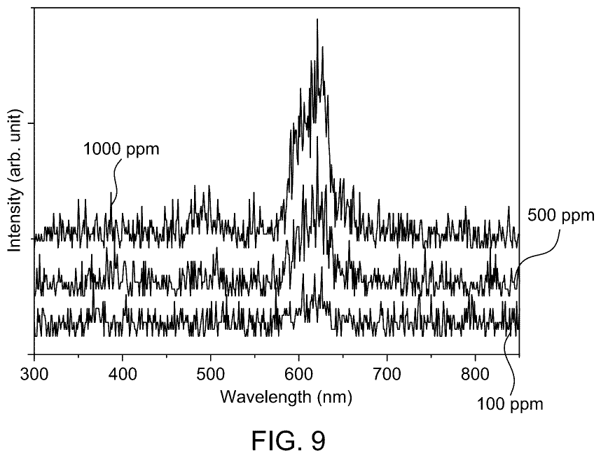

Spectral techniques were also used to detect the MgAl_{0.05}G_{0.95}O₃:0.3% Pr³⁺ NPs in the crude oil/water emulsion. The MgAl_{0.05}G_{0.95}O₃:0.3% Pr³⁺ NPs dispersed in water emit similar three bands in the photoluminescence spectra (FIG. 8A) which is similar to the photoluminescence spectra of the phosphor in the solid-state. A broad peak ranging from 300 to 600 nm from the oil/water emulsion was noted. The spectra of the MgAl_{0.05}G_{0.95}O₃:0.3% Pr³⁺ NPs in the 50/50 crude oil/water emulsion have only the emission from the oil. The results are shown in the photoluminescence spectra in FIG. 8A. When the excitation is stopped and there is no emission from the oil component the emission from the MgAl_{0.05}G_{0.95}O₃:0.3% Pr³⁺ NPs can be observed only. The persistent luminescence emission from the MgAl_{0.05}G_{0.95}O₃:0.3% Pr³⁺ NPs in the water, oil/water, and the MgAl_{0.05}G_{0.95}O₃:0.3% Pr³⁺ NPs in the 50/50 water/oil emulsion is given in FIG. 8B. It is clear from the spectral results that persistent luminescence has advantages over photoluminescence in oilfield sensing. When the MgAl_{0.05}G_{0.95}O₃:0.3% Pr³⁺ NPs dispersed in water were excited at 254 nm for 5 min, the persistent luminescence spectra were recorded. Only a peak in the visible range peaking at 625 nm in the persistent luminescence spectra was observed (FIG. 8B). This peak intensity decreases with a decrease in the concentration of the NPs (FIG. 9). Thus, the spectral acquisition at a lower concentration of the MgAl_{0.05}G_{0.95}O₃:0.3% Pr³⁺ NPs is not possible due to the lower sensitivity of the spectrofluorometer and lower concentration of NPs. So, a CCD camera-based imaging method as described here was adopted.

The low sensitivity of the spectral method, the inherently low afterglow signals of MgAl_{0.05}G_{0.95}O₃:0.3% Pr³⁺ NPs in oil emulsion, and the dense oil phase cause excitation problems of the NPs and resulted in the lower detection of NPs in the oil/water emulsion. Therefore, the IVIS Lumina III imaging system was used for the detection of MgAl_{0.05}G_{0.95}O₃:0.3% Pr³⁺ NPs in the crude oil/water emulsion. The emulsions were tested in quartz cuvettes and were irradiated at 254 nm UV light for 5 min. The images were taken after 1 min of the excitation in a bioluminescence mode with different exposure times of 15 s, 30 s, and 1 min.

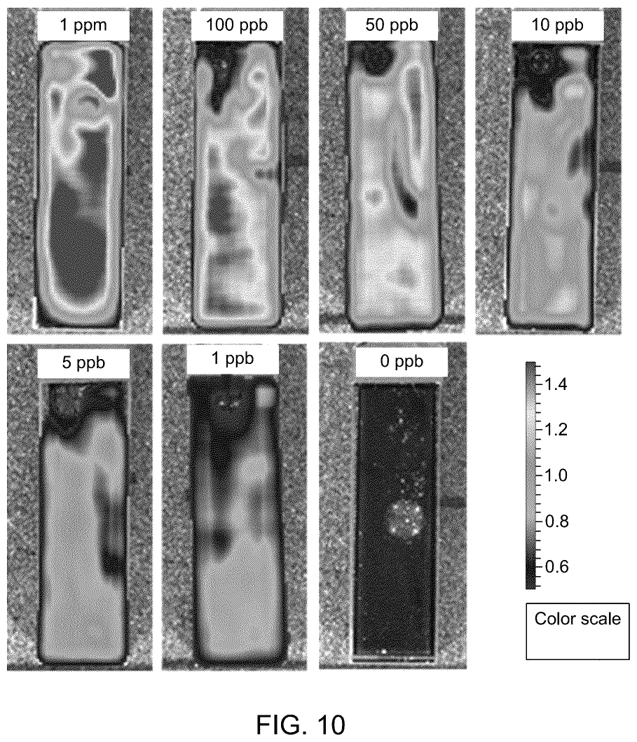

The persistent luminescence images of the different concentrations (0, 1, 5, 10, 50, 100, and 1000 ppb) of the MgAl_{0.05}G_{0.95}O₃:0.3% Pr³⁺ NPs in the 50/50 crude oil/water emulsions are shown in FIG. 10. The 50/50 crude oil/water emulsion without NPs was used as a control to quantify the background noise from the oil/water emulsion. The NPs as low as 0.5 ppb can be visualized by the imaging method. The brightness increases as the concentration of the NPs increases in the emulsion. There was a linear relationship between the average persistent luminescence intensity with the concentration of the MgAl_{0.05}G_{0.95}O₃:0.3% Pr³⁺ NPs (FIG. 10). The average intensity was found by processing the obtained images by Living Image software by the region of interest (ROI) tool (Table 1).

TABLE 1
The images were processed by living image software (Version 4.7.2, PerkinElmer, Inc.).
For the comparison of the images, the images were taken under similar conditions. The
average intensity was found by processing the obtained images by Living Image software
at a binning of 8 and smoothing of 3 × 3 by the region of interest (ROI) tool.

| Concentration of | | | Image | Total Flux | Avg. Radiance | St. dev. | | |
|---|---|---|---|---|---|---|---|---|
| MAGO:Pr NPs | | ROI | Layer | [p/s] | [p/s/cm²/sr] | Radiance | Min Radiance | Max Radiance |
| 1000 | ppb | ROI 1 | Overlay | 7.73E+05 | 1.53E+05 | 9.06E+03 | 1.35E+05 | 1.75E+05 |
| 100 | ppb | ROI 1 | Overlay | 6.53E+05 | 1.29E+05 | 7.05E+03 | 1.02E+05 | 1.44E+05 |
| 50 | ppb | ROI 1 | Overlay | 5.96E+05 | 1.19E+05 | 1.94E+04 | 5.04E+04 | 1.45E+05 |
| 10 | ppb | ROI 1 | Overlay | 5.13E+05 | 1.03E+05 | 1.16E+04 | 7.06E+04 | 1.26E+05 |
| 5 | ppb | ROI 1 | Overlay | 4.94E+05 | 9.79E+04 | 1.60E+04 | 6.77E+04 | 1.35E+05 |
| 1 | ppb | ROI 1 | Overlay | 4.48E+05 | 8.82E+04 | 1.12E+04 | 6.12E+04 | 1.12E+05 |

| | | | | | | | |
|---|---|---|---|---|---|---|---|
| 50/50 oil/water | ROI 1 | Overlay | 3.04E+05 | 5.98E+04 | 7.39E+03 | 3.78E+04 | 8.55E+04 |
| emulsion | | | | | | | |

MgAl_{0.05}Ge_{0.95}O₃:0.3% Pr³⁺ nanophosphors were synthesized by the sol-gel method. The sol-gel method is an alternative to the solid-state synthesis of the said materials. The synthesized persistent phosphor emits in the visible region peaking at 625 nm, the NIR region peaking at 905 nm, and the SWIR region peaking at 1089 nm. The persistent luminescence data shows that when the NPs were excited at 254 nm for 5 minutes the spectra can be obtained after 5 h and the emission at 625 nm can be monitored after 15 h of the stoppage of the excitation. The spectral and imaging methods were used to detect the prepared NPs in the crude oil/water emulsion.

Numerous modifications and variations of the present disclosure are possible in light of the above teachings. It is therefore to be understood that within the scope of the appended claims, the invention may be practiced otherwise than as specifically described herein.

1: A method, comprising:
exciting a nanophosphor tracer with light;
injecting the nanophosphor tracer at a first location in a subterranean geological reservoir, wherein the nanophosphor tracer mixes with a subsurface fluid in the subterranean geological reservoir;
collecting a fluid sample from a second location in the subterranean geological reservoir; and
analyzing the fluid sample to detect a presence of the nanophosphor tracer in the fluid sample,
wherein the nanophosphor tracer, comprises:
MgAlₓGe_{y}O₃:zPr³⁺ nanoparticles,
wherein x and y are each greater than 0 and x+y=1,
wherein z is 0.1-0.5 at. %, relative to total number of atoms in the MgAlₓGe_{y}O₃:zPr³⁺ nanoparticles, and
wherein following the exciting the nanophosphor tracer emits light for at least 3 hours.

2: The method of claim 1, further comprising:
determining a subsurface fluid-flow pattern in the subterranean geological reservoir based on the presence of the nanophosphor tracer in the fluid sample.

3: The method of claim 1, wherein the analyzing comprises:
acquiring a persistent luminescence spectrum of the fluid sample,
wherein the acquiring does not include further exciting of the fluid sample.

4: The method of claim 1, wherein the analyzing comprises:
acquiring a time-dependent persistent luminescence spectrum of the fluid sample,
wherein the acquiring does not include further exciting of the fluid sample.

5: The method of claim 1, wherein the analyzing occurs up to 15 hours after the exciting.

6: The method of claim 1, wherein following the exciting the nanophosphor tracer emits light having a wavelength of 600-650 nm, 900-910 nm, and 1050-1100 nm.

7: The method of claim 1, wherein the nanophosphor tracer emits light having a wavelength of 600-650 nm for up to 15 hours following exciting with 200-300 nm light.

8: The method of claim 1, wherein the MgAlₓGe_{y}O₃:zPr³⁺ nanoparticles have a formula of MgAl_{0.05}Ge_{0.95}O₃:0.3% Pr³⁺.

9: The method of claim 1, wherein the MgAlₓGe_{y}O₃:zPr³⁺ nanoparticles have an orthorhombic crystal structure.

10: The method of claim 1, wherein the MgAlₓGe_{y}O₃:zPr³⁺ nanoparticles have an average size of 10-500 nm.

11: The method of claim 1, wherein the MgAlₓGe_{y}O₃:zPr³⁺ nanoparticles have a concentration of 1-1,000 ppb, based on a total volume of the subsurface fluid.

12: The method of claim 1, wherein the exciting comprises irradiating the nanophosphor tracer with UV light having a wavelength of 200-300 nm for at least 1 minute.

13: The method of claim 1, wherein the analyzing is in real time at the second location.

14: The method of claim 1, further comprising repeating the collecting and the analyzing at 3-50 additional locations.

15: The method of claim 1, further comprising:
repeatedly exciting the nanophosphor tracer following the injecting inside of the subterranean geological reservoir.

16: The method of claim 1, wherein the subsurface fluid comprises at least one of natural gas, crude oil, connate water, or seawater.

17: The method of claim 1, wherein the MgAlₓGe_{y}O₃:zPr³⁺ nanoparticles are made by a method comprising:
mixing an Al salt, Mg salt, GeO₂, and a Pr salt in solvent with a complexing agent to form a first mixture;
dehydrating the first mixture to a temperature of 50-100° C. to form a polymeric complex;
heating the polymeric complex for at least 10 hours at a temperature of 80-110° C. to form a foam;
combusting the foam at a temperature of 400-600° C. to form a powder; and
calcining the powder at a temperature of 500-1,500° C. to form the MgAlₓGe_{y}O₃:zPr³⁺ nanoparticles.

18: The method of claim 17, wherein a molar ratio of the Al salt, Mg salt, GeO₂, and a Pr salt to the complexing agent is 1 to 1-5.
